(19) United States
(12) Patent Application Publication
(10) Pub. No.: US 2015/0342399 A1
(43) Pub. Date: Dec. 3, 2015

(54) Grills for Cooking

(71) Applicants: Kevin Walker Tee, Geneva, IL (US); Dion L van Leeve, Yorkville, IL (US)

(72) Inventors: Kevin Walker Tee, Geneva, IL (US); Dion L van Leeve, Yorkville, IL (US)

(21) Appl. No.: 14/293,877

(22) Filed: Jun. 2, 2014

(51) Int. Cl. A47J 37/07

(52) U.S. Cl. CPC A47J 37/07; A47J 37/0786; A47J 2037/0795

(57) ABSTRACT

A drip tray, a grill having a drip tray, and a kit for retrofitting a grill are disclosed in which a heat source is disposed beneath a cooking grate on which food it to be cooked. A plurality of lava rocks are disposed above the heat source and are selectively moveable closer to, and further away from, the cooking grate. A drip tray may be disposed between the heat source and the lava rocks, with the drip tray having a plurality of openings through which heat from the heat source may pass to heat the lava rocks and having a plurality of grooves through which grease or other liquid which falls onto the drip plate is directed to a suitable collection point.

### FIELD OF THE INVENTIONS

The present invention pertains to grills for cooking foods.

### BACKGROUND OF THE INVENTION

Cooking various meats, vegetables, fruits and other foods over heat has been utilized for centuries around the world. This is often referred to as grilling or barbequing. A wide variety of grills and grilling devices have been developed over the years for facilitating this type of cooking of foods at homes such as in back yards or the like. Some cooks are content to cook their foods at a fairly uniform temperature throughout the cooking process so long as the food is cooked to a desired temperature at the completion of cooking or cooked through to a desired level of completeness such as to a desired texture or the like.

However, some cooks desire to significantly and rapidly change the level of heat imparted to the food, to achieve improved characteristics on their food. For instance, some cooks desire to impart a high initial heat to some foods to achieve, for instance, an initial searing of the outside of the food, and then to impart a lower heat to food for the remainder of the cooking process. Or some cooks may desire to impart a high heat to their food at the end of the cooking process to brown a sauce which has been applied to the food or the like.

A shortcoming of currently available grills is that they do not allow for the desired level of significant and rapid changes in the level of heat imparted to the food.

Another shortcoming of currently available grills is that the grease which drips down from the food being cooked remains near the heat source after it drips down which results in undesirable flare-ups of flame. Flare-ups may cause localized regions of high heat which may cause uneven cooking, and may also cause food cooking directly above a flare-up to become overcooked or burned. There is a need for a grill which allows for significant and rapid changes in the level of heat imparted to the food while reducing the amount of flare-ups which occur during cooking.

### SUMMARY OF THE INVENTION

In accordance with various aspects of the present invention, a grill is provided which allows for significant and rapid changes in the level of heat imparted to the food while reducing the amount of flare-ups which occur during cooking.

In accordance with one aspect of the present invention, a grill is provided having a housing with a heat source, such as a gas flame or charcoals, disposed in the housing, with a cooking grate disposed above the heat source for supporting the food to be cooked. A plurality of volcanic rocks are disposed between the heat source and the cooking grate. A drip tray is disposed between the heating source and the volcanic rocks, with the drip tray having a plurality of openings through which heat may pass directly from the heat source to the volcanic rocks, and with the heat plate also having a plurality of grooves which extend at an angle off of horizontal to direct the grease which falls from the food onto the drip tray during cooking toward a grease collecting point or region for collecting the grease. The drip tray may be used to retrofit existing grills as well.

In accordance with another aspect of the present invention grill conversion kits are provided for converting direct-heat conventional gas or charcoal grills to lava rock grills, which allow for improved cooking methods.

### DESCRIPTION OF THE DRAWINGS

FIG. 1 is a perspective view of a grill illustrating various aspects of the present inventions;

FIG. 2 is a perspective view of an embodiment of a drip tray;

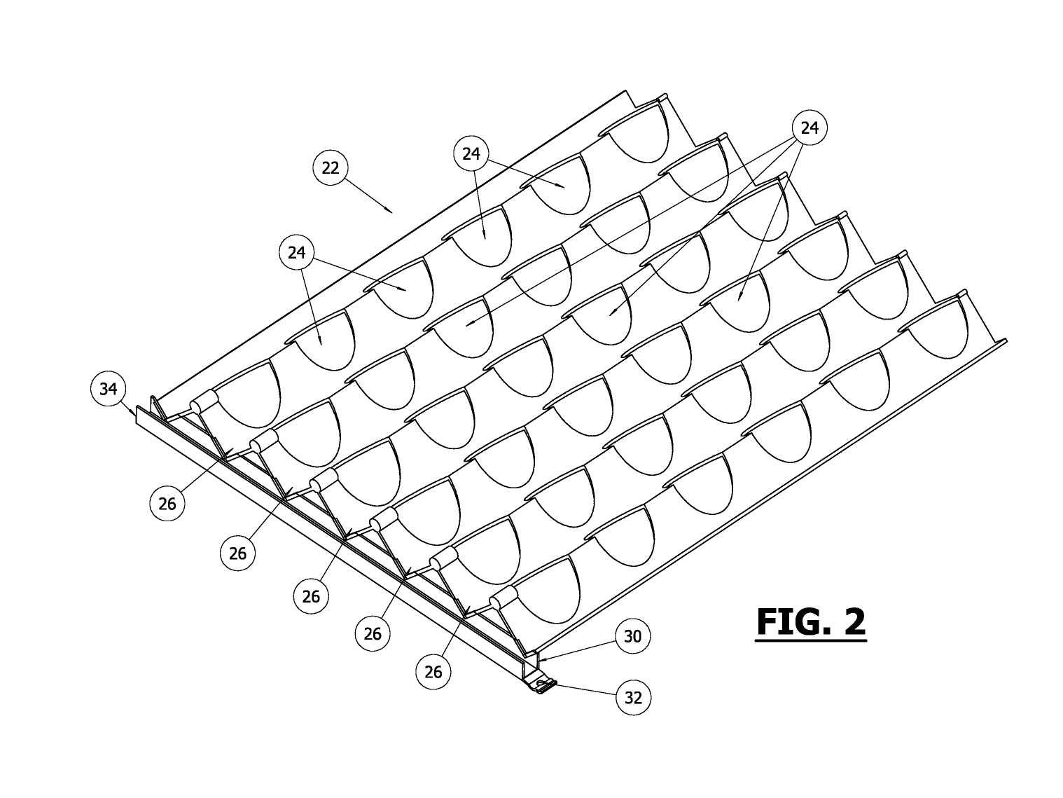

FIG. 3 is a perspective view of an embodiment of a lava rock grate with a drip tray;

FIG. 4 is a side elevational view of a an embodiment of a lava rock grate with a drip tray and a height adjusting mechanism;

FIG. 5 is a perspective view of a grill conversion kit illustrating various features of the present invention;

FIG. 6 is a perspective view of components of a grill conversion kit illustrating various features of the present invention;

FIG. 7 is a perspective view of another embodiment of drip tray;

FIG. 8 is a perspective view of yet another embodiment of drip tray;

FIG. 9 is a perspective view of still another embodiment of drip tray; and

FIG. 10 is a perspective view of a still further embodiment of drip tray.

### DETAILED DESCRIPTION OF THE INVENTION(S)

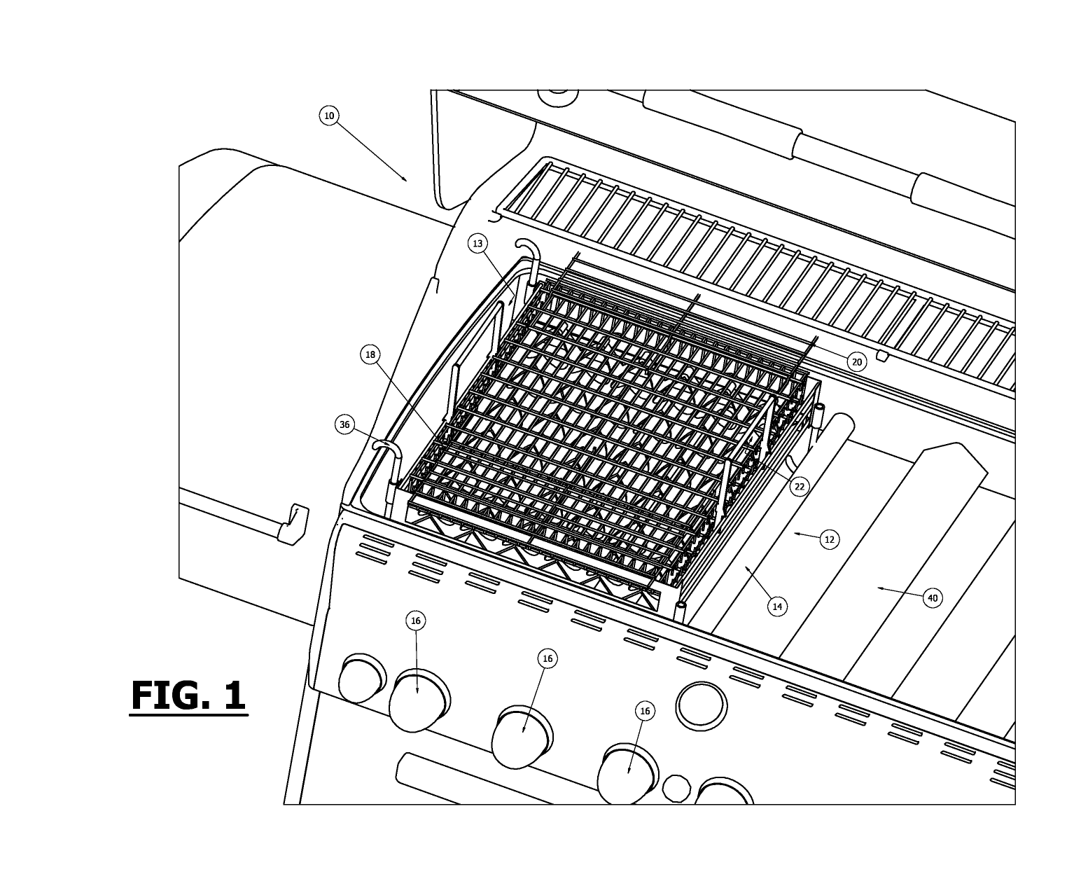

A grill 10 embodying various aspects of the present invention is shown in FIG. 1. The illustrated grill 10 has a heat source 12 in the form of burner tubes 14 through which gas is supplied to, and emitted through, to keep a continuous flame lit. The level of flame, and hence the amount of heat given off from the heat source, is controlled by flame adjusting knobs 16. Though the illustrated grill 10 has several flame adjusting knobs 16 associated with respective burner tubes 14, some grills may have a single flame adjustment mechanism, and may have any of a wide variety of known burner configurations and arrangements. For clarity, the grill of the present invention may also utilize a wide variety of other heat sources, such as electric heating elements, burning charcoal, burning wood, burning other gases, etc. and the invention is not limited to the grill 10 illustrated in FIG. 1.

The heat source 12 is disposed in a housing 13, which may or may not include a cover. A wire basket 18 is shown, which is suitable for containing a plurality of lava rocks (not shown)—as used herein throughout, reference to lava rocks means actual lava rocks or any other heat retaining and distributing stones or ceramics. A wide variety of heat retaining and distributing stones may be suitable for use with the present invention. The desirable rocks or stones are those which are lighter, less dense and more porous that most types of rock, such that they heat up more quickly and provide a nice, even distribution of heat. The plurality of lava rocks are contained in the wire basket 18 which is disposed above the heat source 12 and below the top of the basket 18, whereby the lava rocks promote a sort of oven effect, absorbing the heat produced by the heat source beneath it and radiating it across a larger surface area for more even cooking of food.

A cooking grate 20 is shown resting on the top of the wire basket 18. The cooking grate 20 may be manually lifted off the wire basket 18 and manually placed back on the cooking grate as needed or desired. Alternatively, the cooking grate 20 may be supported on the housing 13 so that it remains stationary even during raising and lowering of the wire basket 18 full of lava rocks (as discussed later).

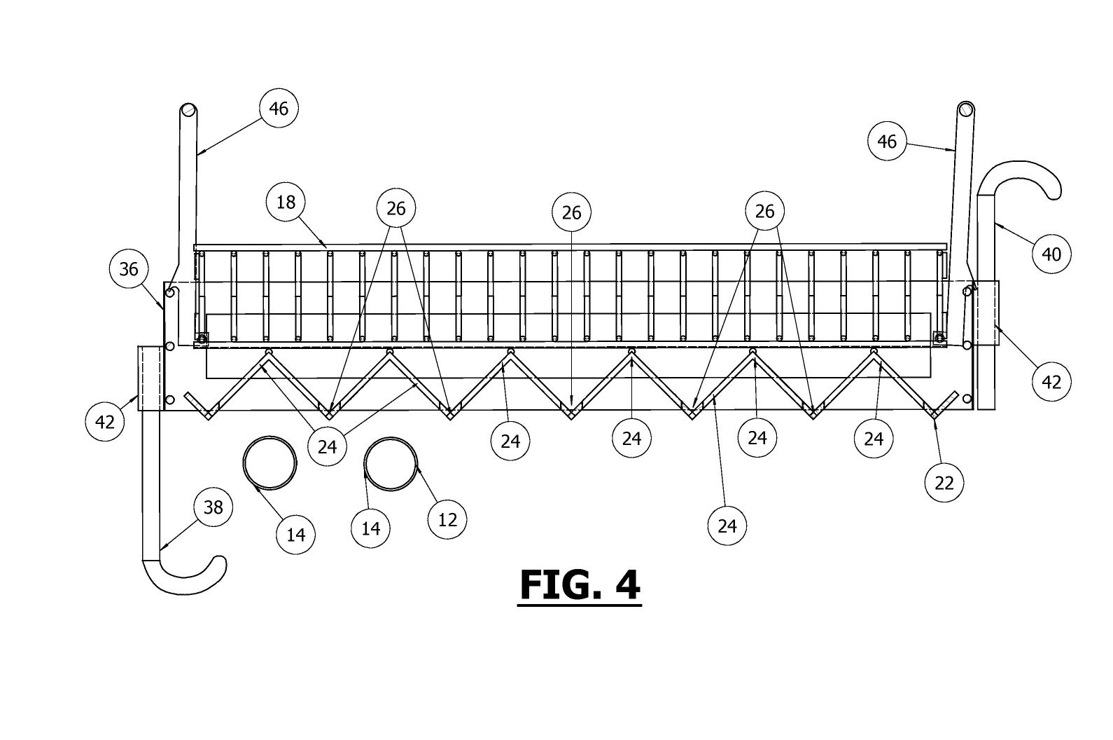

A drip tray 22 is disposed beneath the wire basket 18, such that the drip tray 22 is disposed between the heating source 12 and the volcanic rocks, with the drip tray 22 having a plurality of holes or openings 24 through which heat may pass directly from the heat source 12 to the volcanic rocks contained in the wire basket 18. The illustrated drip tray 22 is configured in a zig-zag shape, as best seen in FIG. 4. Thereby, the tray 22 defines a plurality of grooves 26 at the lower ends or valleys of the zig-zag shaped surfaces, along with the plurality of openings 24 in upper ends or peaks.

Although the illustrated drip tray 22 has sharp changes or turns, a wide variety of surface shapes or configurations may be utilized, such as a sine wave shaped surface or parabolic shaped surface, or any combination of various shapes and configurations. Any drip tray configuration which has openings through which heat may pass while also having grooves or passageways through which grease or other liquids falling down from cooking food onto the drip tray are passed would be suitable for carrying out the present invention.

The drip tray 22 is preferably configured and/or supported such that the grooves 26 extend at an angle off of horizontal to direct the grease or other liquids which may falls from the food onto the drip tray during cooking toward the grease collector. The grooves 26 of the illustrated drip tray 22 angle toward, and feed liquid from the grooves 26, into a grease channel 30 which extends along the lower side of the drip tray 22. The grease channel 30 is in fluid communication with each of the grooves 26, such that grease or other liquid which falls onto the drip tray 22 collects at the bottom of the respective grooves 26 and then flows under the influence of gravity (or other methods of propulsion of fluids and/or greases) into the common grease channel 30. The grease channel 30 is, in turn, angled off of horizontal, with its front end 32 lower than its rear end 34, whereby liquid flows forward in the grease channel 30 toward the front end. A grease collector 34 such as a metal container or the like, is disposed beneath the front end 32 of the grease channel 30 such that liquid flows from the front end 32 of the grease channel 30 down into the grease collector 34. Of course the grease channel 30 may alternatively be angled downward toward its rear. Another advantage of the drip tray 22 is that it keeps the grill 10 clean by directing a significant portion of the grease and other liquids which fall from cooking food into a grease collector 34 which stores the grease and other liquids for disposal at a later time.

A wide variety of surface configurations and groove configurations may be utilized with the drip tray 22, such as for instance the drip tray having a “V” shape with both sides of the drip tray being higher than the center of the tray, with the grooves angled toward the center of the drip tray and the center of the drip tray defining a groove for directing the grease and other liquids into the grease collector. The grease collector 34 is preferably disposed sufficiently distant or isolated from the heat source that the contents of the grease collector do not catch on fire.

The openings 24 in the drip tray 22 preferably are sized to provide an area sufficient for the heat from the heat source 12 to rapidly heat the lava rocks to a high searing temperature or other high desired temperature. The surface area of the drip tray 22 is preferably sufficient to provide a significant reduction in the amount of grease or other liquid which falls from the food as it is cooking from falling into the grill such as on or near the burners, so as to provide a significant reduction in the amount of flare-ups of grease during cooking.

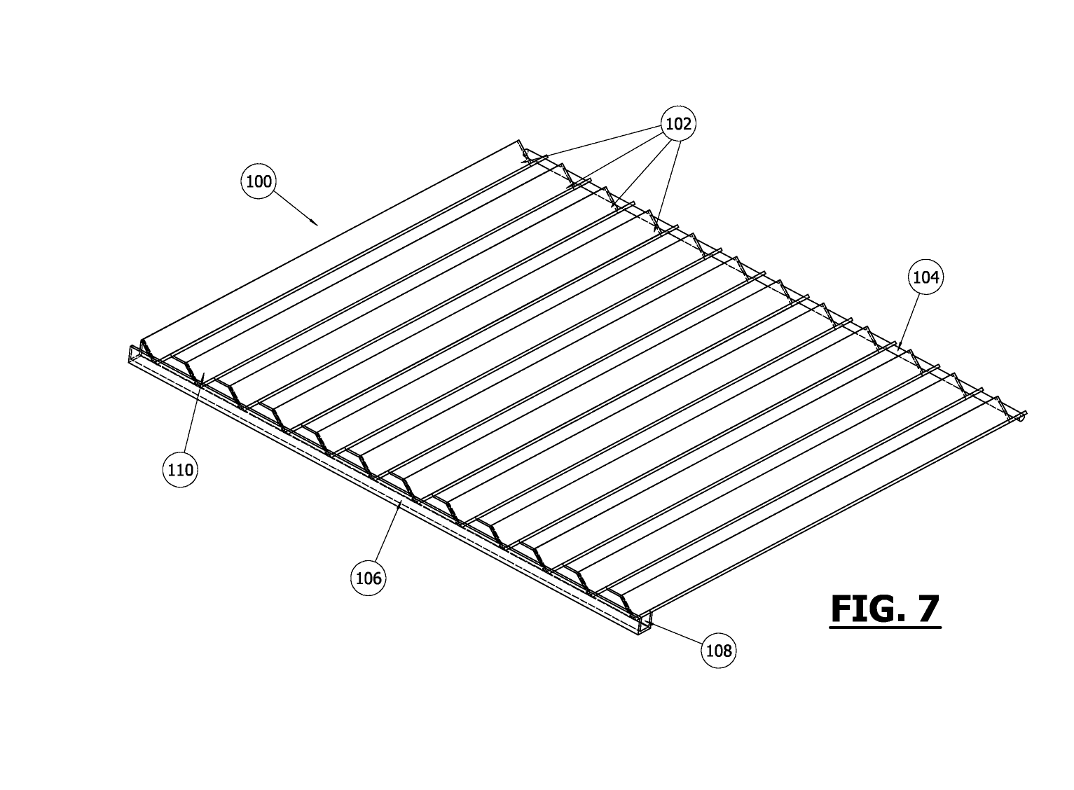

Various alternative drip tray configurations are illustrated in FIGS. 7-9. The drip tray 100 of FIG. 7 has a plurality of v-shaped channel members 102 extending between a first support bracket 104 and a second support bracket 106. The second support bracket 106 defines a channel 108 in fluid communication with each of the v-shaped channel members 102. Grease or other liquid falling onto the v-shaped channel members 102 progresses toward the bottom 110 of the v-shaped channel members 102 and toward the channel 108, from which it may flow to a grease collector or the like.

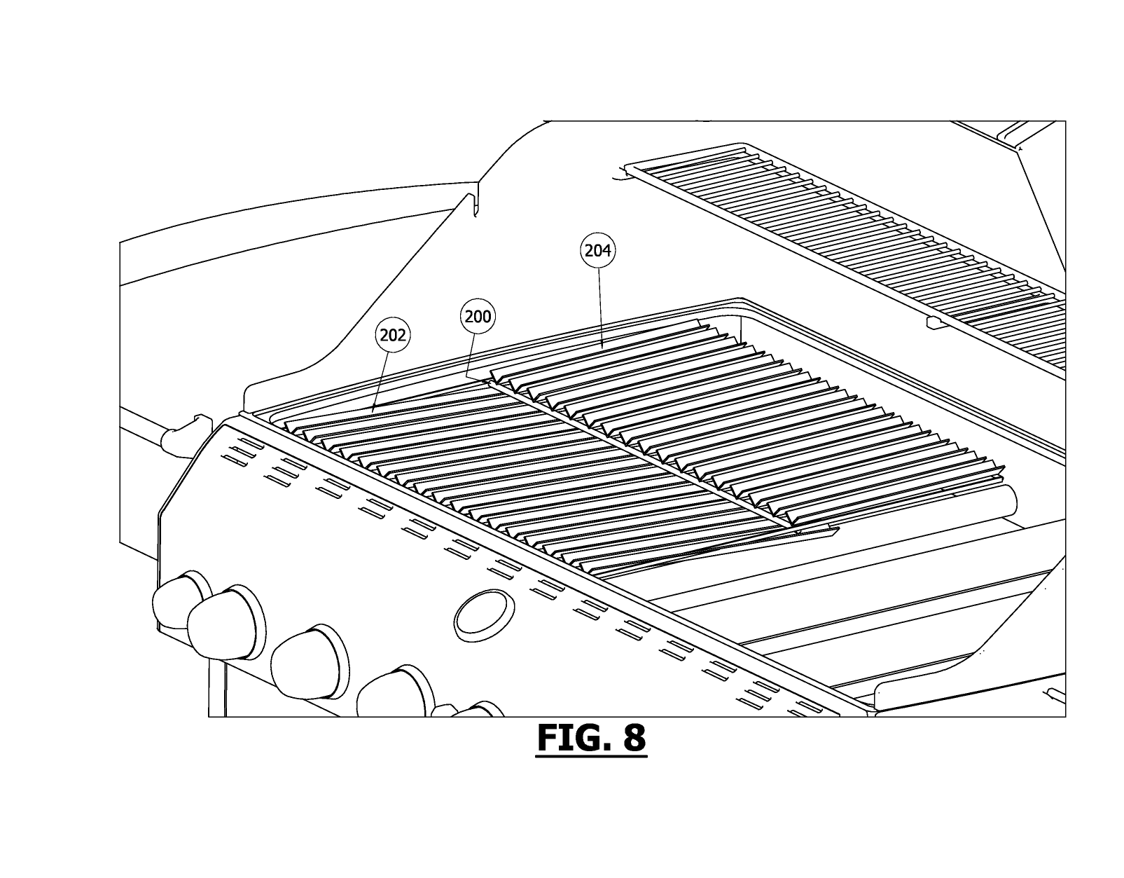

The drip tray 200 of FIG. 8 has two sets of v-shaped channel members: first set 202 and second set 204, both of which may be supported to extend off of horizontal, with the first set of v-shaped channel members 202 being angled toward the center of a grill and the second set of v-shaped channel members 204 also being angled toward the center of a grill and overlapping above a portion of the first set of v-shaped channel members 202 so that grease and other liquid which falls onto the second set of v-shaped channel members 204 progresses off the lower end of the second set of v-shaped channel members 204 and onto the first set of v-shaped channel members 202. Thereafter it may fall off the lower end of the first set of v-shaped channel members 202 and into a grease collector or the like.

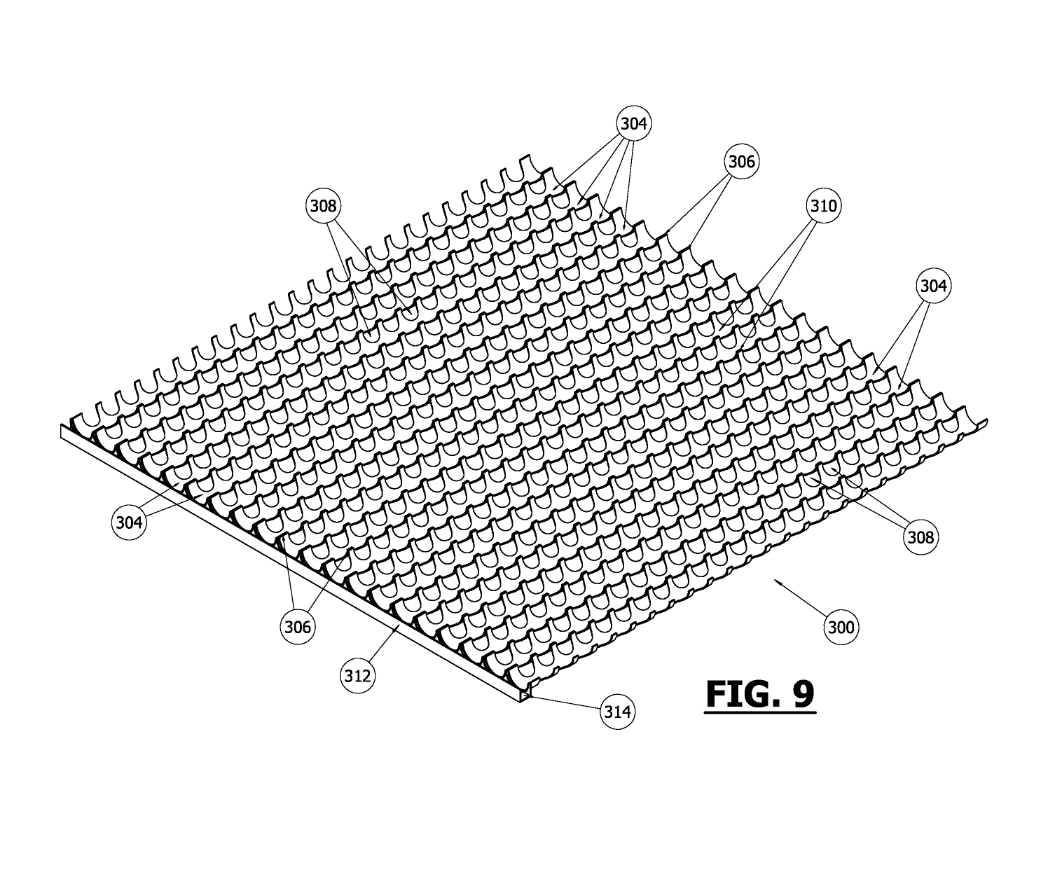

Yet another drip tray configuration is illustrated in FIG. 9. The illustrated drip tray 300 is a continuous metal structure 302 which defines a plurality of u-shaped channels 304 having peaks 306 with openings 308 and valleys 310 defining channels 304 for directing grease and other liquids from the drip tray toward the grease collecting channel 312 when the drip tray is supported at any angle downwardly toward the grease collecting channel. The grease collecting channel 312 defines a draining groove 314 from which the grease and other liquids may pass from the grease collecting channel 312 to a suitable grease collector.

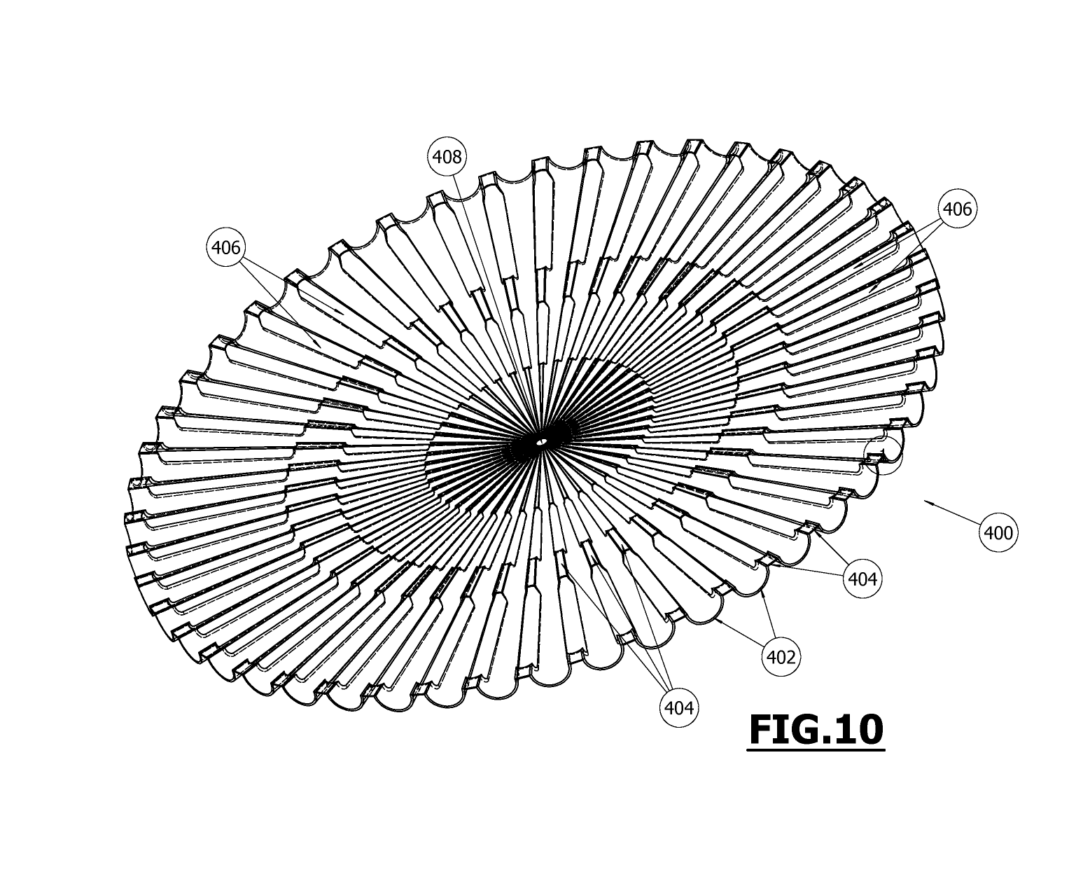

Yet another embodiment of drip tray is disclosed in FIG. 10. The drip tray 400 has a plurality of channels 402 which extend radially inwardly and angled downward toward a central opening 408 which may communicate with a suitable grease collector so that grease and other liquid falling onto the channels 402 flows down the channels 402 toward the central opening 408 and down into a grease collector. The channels 402 are interconnected by short ribs 404 which provide spacing between adjacent channels 402 to define openings 406 through which heat may pass.

A wide variety of other configurations of drip trays may be utilized without departing from the inventive concepts herein, and the various drip tray embodiments set forth herein are merely illustrative of but a very small representative number of examples of drip trays of the present invention.

With reference now to FIG. 4, the wire basket 18 containing the lava rocks is engaged with a height adjusting mechanism 36 that allows for adjustment of the distance of the bed of volcanic rocks in the wire basket 18 relative to the cooking grate 20. The height adjusting mechanism may provide two or more specific positions/heights or be selectively variable at any position/height. The illustrated height adjusting mechanism 36 has one or more lower support bars 38 which extend through collars 42 and rest on a bottom surface inside the housing 13 (as best seen in FIG. 1) to support the wire basket 18 of lava rocks at a selective proximity relative to the heat source. The lower support bars 38 slide through their collars 42 to allow for raising and lowering the position of the wire basket 18 relative to the heat source 12. Additionally, or alternatively, the height adjusting mechanism 18 may have one or more upper support bars 40 which extend through collars 42 and may hang from a surface of the housing or other surface to support the wire basket 18 at a selective position. Handles 46 are engaged with the wire basket 18 and allow for releasing the wire basket from the height adjusting mechanism 36 so the wire basket 18 containing the lava rocks may be slid upward or downward to various positions at different distances from the heat source while the handles are pulled inwardly, and the wire basket 18 being secured in a stationary position at which it has been adjusted upon release of the handles.

It will be appreciated that any of a wide variety of height adjusting mechanisms are well known, and a wide variety of height adjusting mechanisms would be suitable for allowing adjustment of the height or distance of the lava rocks relative to the cooking grate 20 and heat source 12. Grill height adjustment mechanisms are also known which allow for adjustment of the height of a grill and/or heat source outside of the housing, so that the cover of the grill may remain closed throughout cooking, which may be particularly desirable if smoking techniques are to be employed.

Accordingly, the grill 10 of the present invention has a height adjusting mechanism which allows for movement of the wire basket 18 of lava rocks between a first position in sufficiently close proximity to the heat source 12 and sufficiently distant from the cooking grate 22 that the volcanic rocks are heated by the heat source 12 to increase the temperature of the volcanic rocks to a temperature sufficient to sear the food on the cooking grate 22 if the volcanic rocks were brought sufficiently close to cooking grate 22, but which does not sear the food on the cooking grate when the volcanic rocks are in the first position due to the distance between the lava rocks and the food. The wire basket 18 of lava rocks is also moveable to a second position in which the volcanic rocks are disposed sufficiently close to the cooking grate 22 to sear the food on the cooking grate when the volcanic rocks have been heated sufficiently.

One cooking technique which the present invention facilitates is moving the wire basket 18 of lava rocks to its lowest position, turning the heat source 12 to its highest setting, and heating the lava rocks until the temperature of the lava rocks is at least sufficient to sear the food to be cooked, or another desired high temperature (which may be determined by the lava rocks beginning to glow red, or the like). After the lava rocks have been heated to the desired searing temperature, the wire basket 18 of lava rocks is raised to a higher position sufficiently close to the cooking grate 20 to sear the food placed on the cooking grate for cooking. The volume and density of lava rocks in the wire basket 18 is preferably sufficient to keep radiating heat at a high enough temperature and for sufficiently long to allow the food to be seared fully on both sides. After the food has been seared as desired under high heat, the wire basket may be lowered again and/or the heating unit lowered to allow the food to cook further under lower heat.

With reference again to FIG. 1, the present invention may also be utilized as a conversion kit for retrofitting exiting grills. A conventional gas grill is illustrated on the right side of FIG. 1, with a plurality of burner tubes 14 controlled by flame adjusting knobs 16 disposed within a housing 13, and with “inverted V” shaped bars 40 extending over each of the burner tubes 14. The housing 13 supports a cooking grate on which food is supported for cooking in a stationary position above the burner tubes 14. With this type of conventional gas grill, the temperature at which the food is cooked is only variable or primarily variable only by adjusting the flame level through the flame adjusting knobs 16.

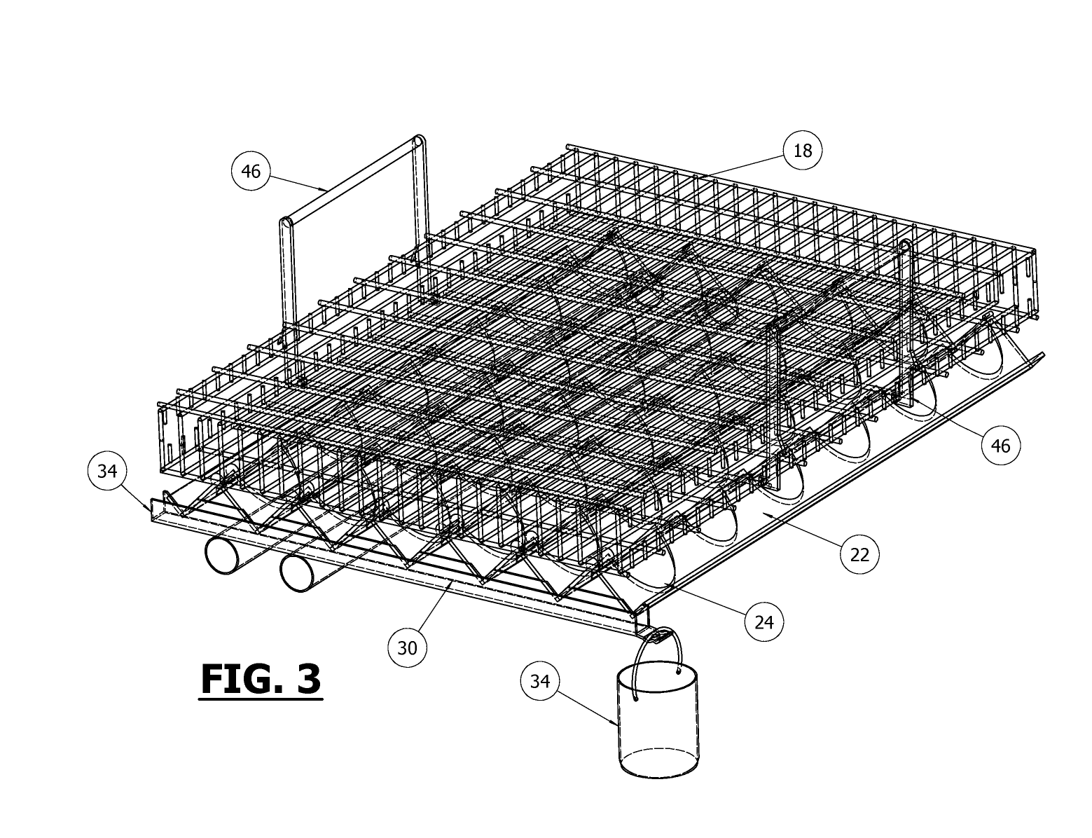

A conversion kit 44 may be utilized to convert such a conventional direct gas grill to a lava rock grill embodying various aspects of the present invention. The illustrated conversion kit has a wire basket 18 containing lava rocks (or suitable for containing lava rocks which may be provided separately) disposed above a drip tray which has a plurality of openings 24 through which heat may pass directly from the heat source of the conventional grill to the volcanic rocks to heat the volcanic rocks to a high temperature, preferably heat the volcanic rocks quickly to a high temperature, with the drip tray also having a plurality of grooves which extend at an angle off of horizontal to direct the grease which falls from the food onto the drip tray during cooking into a grease collector 34. FIGS. 3 and 4 show various aspects of conversion kits showing various features of the present invention. With reference to FIGS. 1, 3 and 4 the conventional grill may be opened and the inverted V-shaped bars removed from over the flame tubes, and the then the conversion kit placed inside the grill and supported by its upper and/or lower support bars 38 and 40 inside the grill housing such that the wire basket 18 and drip tray 22 are supported above the flame tubes or other heat source.

The conversion kit is also well suited for use with charcoal grills, with the conversion kit being supported by the housing of the charcoal grill above the charcoal, and the wire basket 18 of lava rocks adjustable relative to the hot coals during cooking.

As used herein, zig-zag refers to repeating “W” and/or “V” shapes as well as sinusoidal shapes and/or parabolic shapes, etc. which define alternating upper ridges or peaks and lower valleys or channels.

Alternatively, the channel 30 may serve as the grease collector, without the need to flow the grease to a separate grease collector. For instance, a disposable metal insert may be provided in the channel 30 for collecting the grease, which collected grease may be discarded along with the disposable metal insert after the insert is filled with grease and new empty disposable insert placed the channel before starting a new grilling.

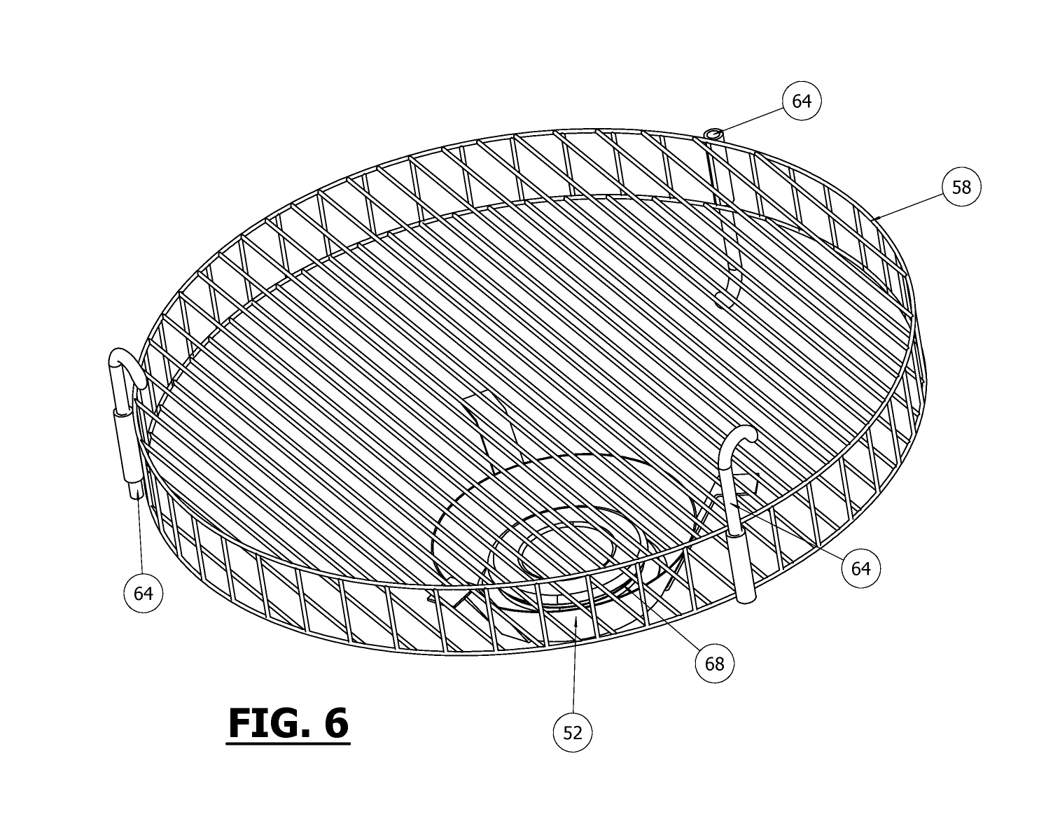

Another embodiment of grill conversion kit illustrating various aspects of the present invention is illustrated in FIGS. 6 and 7. This embodiment of grill conversion kit 50 lends itself particularly to use in kettle or drum type of grills having a round or egg shape and which are originally sold as charcoal burning grills. The retrofit grill has two separate components: a gas burner component 52 and a basket-drip plate component 54.

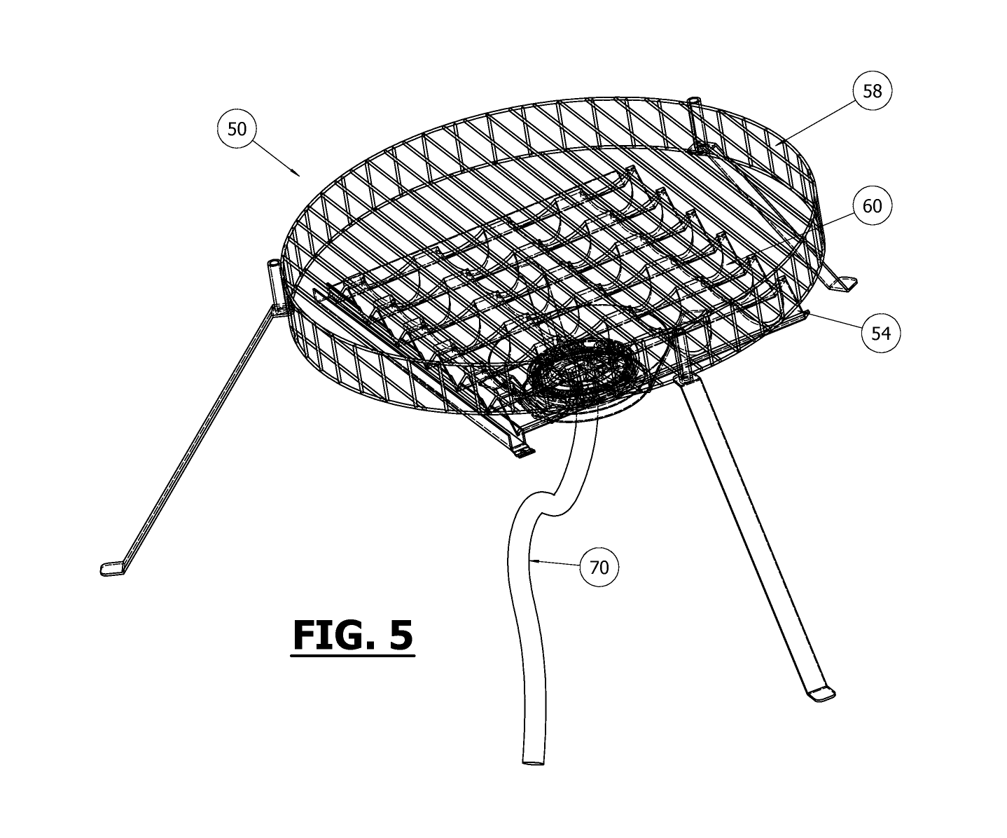

The basket-drip plate component 54 is substantially as discussed above having a wire basket 58 for containing lava rocks connected with a drip plate 60 having the features discussed above disposed below the wire basket 58, and having a plurality of legs 62 connected with the wire basket 58 such as in FIG. 5 which legs 62 rest on the inside of the grill housing for supporting and retaining the wire basket 58 (or adjusting arms 64 such those shown in FIG. 6 which support by hanging downwardly and/or resting on a bottom surface of the housing) and the drip plate 60 disposed beneath it, at a predetermine height above a heat source 52. The plurality of legs and/or support arms are preferably part of a support arrangement which allows the wire basket to be raised and lowered relative to the heat source.

The gas burner component comprises a burner unit 68 for resting on the bottom of the inside grill housing, with a source of fuel (not shown) such as gas disposed outside of the grill housing, and a tube 70 extending from the fuel source to the burner 68. The burner unit 68 may be placed and secured in the housing #, with the tubing 70 run from the burner unit 68 out through one of the venting openings # provided in the bottom of the grill, and connected to the fuel source disposed outside the housing. The fuel source also preferably contains a flow control device by which the flame level may be selectively adjusted.

In some embodiments, the lava rocks may form a full barrier between the heat source and the cooking grate, such that no gases or fumes coming from the heat source fuel pass directly from the heat source to the food, which may eliminate unwanted flavors of the heat source being transferred to the food being cooked to provide for better tasting food. In such embodiments, the lava rocks may catch all of the juices which fall from the cooking food and steam up to provide improved flavoring of the food being cooked.

In some embodiments the lava rocks may be disposed only at, or predominantly at, the openings in the drip tray. In some embodiments, the lava rocks may completely cover the openings and form a full barrier as discussed above.

Concentrating the heat source from which the food is cooked by absorbing heat in the lava rocks and then distributing the heat from the lava rocks to cook the food, with the lava rocks being moved into close proximity to the food, allows for grilling at lower ambient temperatures and in more windy conditions than a conventional grill having a stationary heat source disposed further from the food during cooking. This may also provide a savings in the amount of fuel (heat source) required to be used in cooking the food. Also, this may allow for more accuracy and control of the temperature in the grilling of foods at low temperatures, since the close proximity of the lava rocks to the food reduces the cooking temperature variabilities that may be caused by such things as variations in ambient temperature and wind speed during cooking.

Although the invention is described by way of preferred embodiments, the invention is not limited to the specific embodiments set forth therein, which are provided for illustrative purposes only. Rather, the invention is defined by the following claims which form a part of this patent application.

What is claimed is:

1. A grill for cooking food that may produce grease when it is heated, comprising:
a housing;
a heat source disposed within the housing;
a cooking grate disposed above the heat source for supporting the food to be cooked;
a plurality of volcanic rocks disposed between the heat source and the cooking grate;
a grease collector for receiving and storing grease; and
a drip tray disposed between the heating source and the volcanic rocks, with the drip tray having a plurality of openings through which heat may pass directly from the heat source to the volcanic rocks, and the drip tray also having a plurality of grooves which extend at an angle off of horizontal to direct the grease which falls from the food onto the drip tray during cooking toward the grease collector.

2. A grill in accordance with claim 1 in which the drip tray has a corrugated surface which defines a plurality of channels having peaks and valleys with the openings being provided at the peaks and the valleys defining the grooves.

3. A grill in accordance with claim 1 in which the grooves of the drip plate extend at a sufficient enough angle off of horizontal to convey at least a substantial potion of the grease which drips from food cooking on the cooking grid onto the drip tray away from under the food sufficiently to reduce grease flare-ups occurring under the cooking food.

4. A grill in accordance with claim 1 in which the plurality of volcanic rocks are contained in a wire basket.

5. A grill in accordance with claim 1 in which the volcanic rocks are supported by a height adjusting mechanism that allows for adjustment of the distance of the volcanic rocks relative to the cooking grate.

6. A grill in accordance with claim 5 in which the height adjusting mechanism allows for movement of volcanic rocks between:
a first position in sufficiently close proximity to the heat source and sufficiently distant from the cooking grate that the volcanic rocks are heated by the heat source to increase the temperature of the volcanic rocks to a temperature sufficient to sear the food on the cooking grate if the volcanic rocks were brought sufficiently close to cooking grate, but which does not sear the food on the cooking grate when the volcanic rocks are in the first position, and;
a second position in which the volcanic rocks are disposed sufficiently close to the cooking grate to sear the food on the cooking grate when the volcanic rocks have been heated sufficiently.

7. A grill in accordance with claim 5 in which the adjustment mechanism is operable from outside of the housing.

8. A grill in accordance with claim 6 in which the height adjusting mechanism is also adjustable to any selective position between the first position and the second position.

9. A grill in accordance with claim 2 in which the peaks and valleys of the drop tray extend generally radially toward the center of the drip tray.

10. A grill in accordance with claim 1 in which volcanic rocks are disposed at the openings.

11. A grill in accordance with claim 10 in which the volcanic rocks at least substantially cover the openings.

12. A grill conversion kit for converting a conventional grill having a stationary heat source disposed in a housing and having a cooking grate supported on the housing above the heat source, the conversion kit comprising:
a wire basket containing lava rocks;
a drip tray disposed beneath the wire basket of lava rocks, the drip tray having a plurality of openings through which heat may pass directly from the heat source to the volcanic rocks, and the drip tray also having a plurality of grooves which extend at an angle off of horizontal to direct the grease which falls from the food onto the drip tray during cooking; and
a grease collector fluidly connected with the drip tray for receiving and storing the grease directed from the drip tray.

13. A grill conversion kit in accordance with claim 12 further comprising a variable gas heat source disposable in the grill housing beneath the rest of the grill conversion kit.

14. A grill conversion kit in accordance with claim 12 in which the variable heat source comprises a source of gas disposed outside of the grill housing, a burner suitable for being disposed in the grill housing, and tubing extending from the source of gas to the burner.

15. A conversion kit in accordance with claim 12 further comprising a height adjusting mechanism for selectively adjusting the height of the wire basket containing lava rocks relative to the heat source.

16. A conversion kit in accordance with claim 15 in which the height adjustment mechanism has handles which extend upwardly on either side of the cooking grate.

17. A drip tray for use on a grill to reduce grease flare-ups associated with grease dripping from food during cooking, the drip tray comprising:
a metal structure defining alternating grooves and openings; and
the grooves being angled off of horizontal to direct grease which falls from the food onto the drip tray during cooking toward a desired collection point.

18. A drip tray in accordance with claim 17 further comprising a grease collector in fluid communication with the collection point of the drip tray.

19. A drip tray in accordance with claim 17 in which the metal structure comprises a corrugated sheet having a plurality of openings and also having a plurality of grooves which extend at an angle off of horizontal to direct the grease which falls from the food toward the desired collection point.

20. A drip tray in accordance with claim 19 in which the metal structure comprises a plurality of v-shaped channels.
